(19) United States
(12) Patent Application Publication
(10) Pub. No.: US 2012/0164959 A1
(43) Pub. Date: Jun. 28, 2012

(54) APPARATUS AND METHOD FOR TRANSMITTING MULTI MILLIMETER WAVE

(75) Inventors: Sung Eun Kim, Seoul (KR); Sung Weon Kang, Daejeon (KR); Jung Hwan Hwang, Daejeon (KR); Tae Young Kang, Seoul (KR); Kyung Soo Kim, Daejeon (KR); Jung Bum Kim, Daejeon (KR); Jin Kyung Kim, Daejeon (KR); Kyung Hwan Park, Daejeon (KR); Hyung-il Park, Daejeon (KR); In Gi Lim, Daejeon (KR); Byoung Gun Choi, Daegu (KR); Chang Hee Hyoung, Daejeon (KR); Tae Wook Kang, Daejeon (KR)

(73) Assignee: Electronics and Telecommunications Research Institute, Daejeon (KR)

(21) Appl. No.: 13/307,269

(22) Filed: Nov. 30, 2011

(30) Foreign Application Priority Data
Dec. 23, 2010 (KR) 10-2010-0134053

(51) Int. Cl. H04B 1/02

(52) U.S. Cl. 455/91

(57) ABSTRACT

Provided is an apparatus and method for transmitting a multi millimeter wave, which can minimize signal interference and crosstalk between devices using millimeter waves as transmission frequencies. The apparatus includes a scanner, a physical layer controller and a physical layer. The scanner searches for a peripheral communication environment. The physical layer controller selects a transmission mode from the physical layer based on the peripheral communication environment searched by the scanner. The physical layer has a plurality of transmission modes and outputs a millimeter wave to an outside through an antenna in the transmission mode selected under a control of the physical layer controller.

### CROSS-REFERENCES TO RELATED APPLICATIONS

The present application claims priority under 35 U.S.C 119(a) to Korean Application No. 10-2010-0134053, filed on Dec. 23, 2010, in the Korean Intellectual Property Office, which is incorporated herein by reference in its entirety set forth in full.

### BACKGROUND

Exemplary embodiments of the present invention relate to an apparatus and method for transmitting a multi millimeter wave, and more particularly, to an apparatus and method for transmitting a multi millimeter wave, which can minimize signal interference and crosstalk between devices using millimeter waves as transmission frequencies.

Attempts for a few Gbps-grade radio transmission has recently been made with the development of digital video media technology and the increase in requirement for high-speed radio transmission. As a result, millimeter waves are used as transmission frequencies.

As the millimeter waves are used as transmission frequencies, signal bandwidths are also broadened, and thus a large amount of frequency resources can be used.

However, technical obstacles remain until radio data transmission technology using millimeter waves is developed and commercialized.

Two or more signal transmission sources may exist in the same space due to characteristics in radio data transmission. In this case, transmitters and receives necessarily take an action for minimizing the phenomenon that a signal generated from one signal transmission source is interfered by a signal generated from another signal transmission source.

The technical configuration described above is a background art for better understanding of the present invention, but is not a prior art well-known in the technical field pertinent to the present invention.

### SUMMARY

An embodiment of the present invention relates to an apparatus and method for transmitting a multi millimeter wave, in which in a case where there exist different millimeter wave signals through scanning of a peripheral communication environment when transmitting a millimeter wave, the millimeter wave is transmitted by selecting an appropriate transmission mode in the scanned environment, so that it is possible to minimize signal interference and crosstalk.

In one embodiment, an apparatus for transmitting a multi millimeter wave includes a scanner configured to search for a peripheral communication environment, a physical layer controller configured to select a transmission mode from a physical layer based on the peripheral communication environment searched by the scanner, and the physical layer configured to have a plurality of transmission modes and to output a millimeter wave to outside through an antenna in the transmission mode selected by the physical layer controller.

The physical layer may convert a transmission frequency, a modulation method and a code rate based on the selected transmission mode under the control of the physical layer controller.

The peripheral communication environment may include information on a transmission frequency, a modulation method and a code rate, which are currently used in another transmission source.

In another embodiment, a method for transmitting a multi millimeter wave includes searching for a peripheral communication environment through a scanner, selecting another transmission mode based on the peripheral communication environment when another transmission source exists as the searched result, and outputting a millimeter wave to outside in the selected transmission mode.

The method may further include maintaining an existing transmission mode when another transmission source does not exist as the searched result.

As described above, according to the present invention, in a case where there exist different millimeter wave signals through scanning of a peripheral communication environment when transmitting a millimeter wave, the millimeter wave is transmitted by selecting an appropriate transmission mode in the scanned environment, so that it is possible to minimize signal interference and crosstalk of signals between transmission sources that exist in the same space.

Accordingly, it is possible to take action for a changed peripheral environment and transmit a signal in an optimized environment.

### BRIEF DESCRIPTION OF THE DRAWINGS

The above and other aspects, features and other advantages will be more clearly understood from the following detailed description taken in conjunction with the accompanying drawings, in which:

FIG. 1 illustrates a configuration of an apparatus for transmitting a multi millimeter wave according to an embodiment of the present invention;

FIG. 2 illustrates a case where the apparatus for transmitting the multi millimeter wave is applied to a vehicle according to the embodiment of the present invention; and

FIG. 3 illustrates a method for transmitting a multi millimeter wave according to an embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

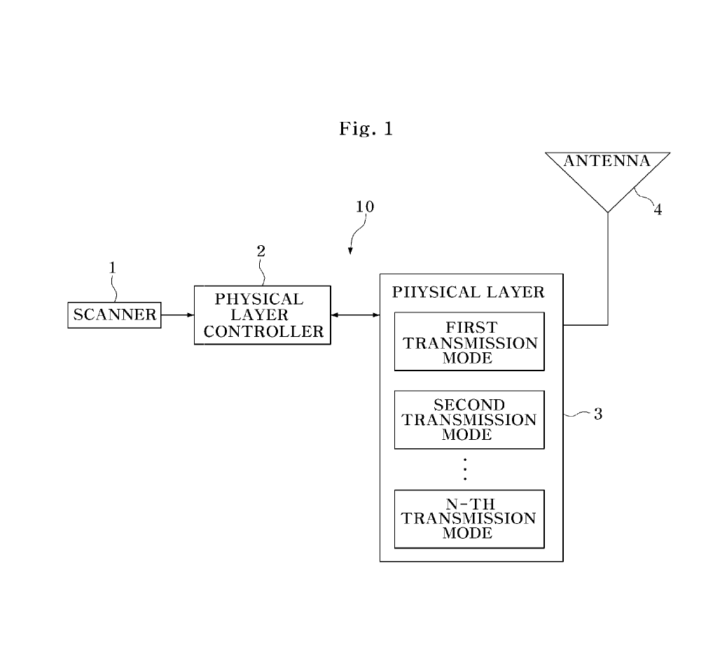

FIG. 1 illustrates a configuration of an apparatus for transmitting a multi millimeter wave according to an embodiment of the present invention.

Referring to FIG. 1, the apparatus 10 according to the embodiment of the present invention includes a scanner 1 for searching for an external communication environment, a physical layer controller 2 for controlling a physical layer 3, the physical layer 3 having a plurality of transmission modes, and an antenna 4 for outputting a millimeter signal.

The scanner 1 detects information on a transmission frequency, a modulation scheme and a code rate, which are currently used, by searching for a peripheral communication environment. The scanner 1 detects a frequency signal with a range in which the information can be outputted and transfers the detected frequency signal to the physical layer controller 2.

The physical layer controller 2 selects an appropriate transmission mode from the physical layer 3, based on the searched result of the scanner 1.

The physical layer 3 transmits a millimeter wave through the antenna 4 in the selected transmission mode. Alternatively, the physical layer 3 is configured so that the modulation scheme, the transmission frequency and the code rate can be converted in the selected transmission mode.

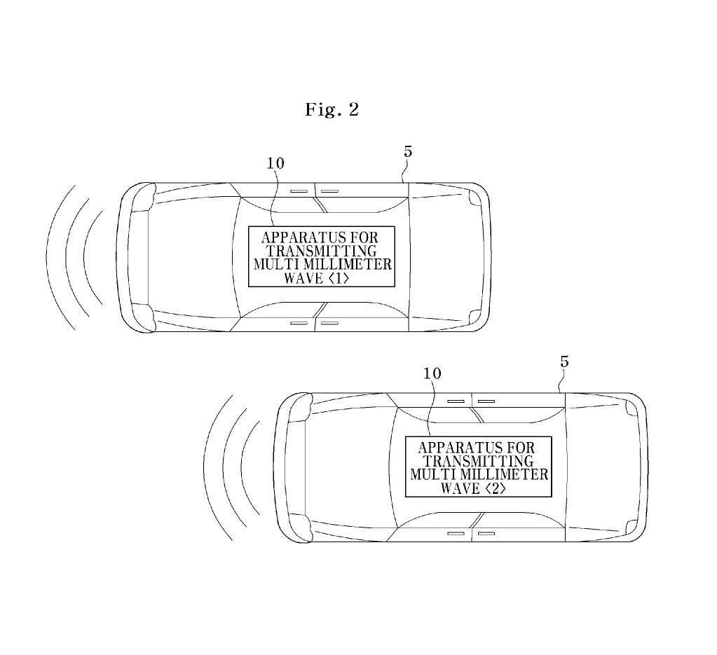

The apparatus for transmitting the multi millimeter wave can be applied as illustrated in FIG. 2.

FIG. 2 illustrates a case where the apparatus for transmitting the multi millimeter wave is applied to a vehicle according to the embodiment of the present invention.

Referring to FIG. 2, if a second vehicle 6 with the built-in apparatus 10 approaches a first vehicle 5 with the built-in apparatus 10, the apparatus 10 built in the second vehicle 6 searches for a peripheral communication environment through the scanner 1.

In a case where it is decided that a new transmission source exists after the peripheral communication environment is searched, the apparatus 10 in the second vehicle 6 selects an appropriate transmission mode based on data received from the scanner 1 and outputs a millimeter wave through the antenna 4.

The apparatus 10 of the first vehicle 5 recognizes that a new apparatus has approached through the scanner 1. However, since the second vehicle 6 that first detected signal interference has first changed the transmission mode, the first vehicle 5 maintains its transmission mode as it is, and thus the interference of signals between the two apparatuses 10 does not occur.

In a case where two apparatuses 10 exist in the same space as described above, the apparatus that has first detected crosstalk between signals changes its transmission mode. In a case where two or more apparatuses 10 simultaneously detect the crosstalk between signals, each of the apparatuses 10 may change its transmission mode into an appropriate transmission mode.

Alternatively, it is possible to perform a method in which each of the apparatuses 10 changes its transmission mode into an appropriate transmission mode through communication between the apparatuses 10.

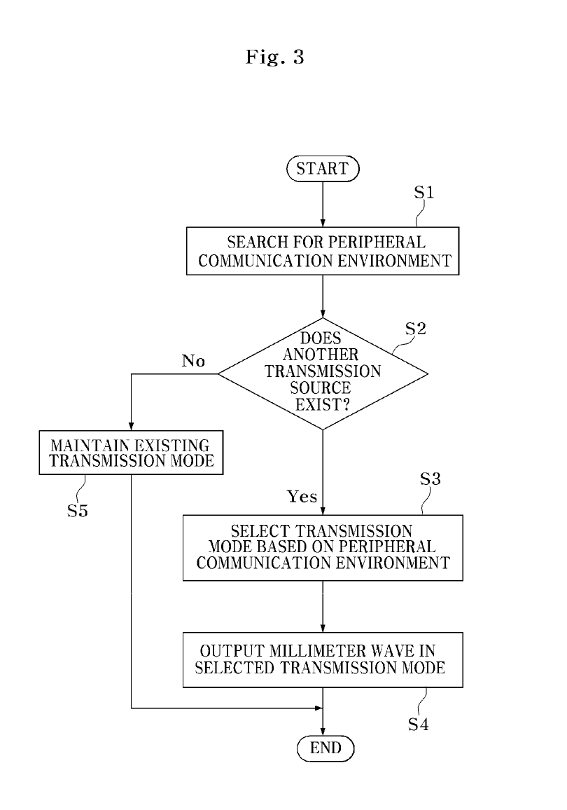

FIG. 3 illustrates a method for transmitting a multi millimeter wave according to an embodiment of the present invention.

First, the scanner 1 detects information on a transmission frequency, a modulation scheme and a code rate, which are currently used, by searching for a peripheral communication environment. The scanner 1 detects a frequency signal with a range in which the information can be outputted and transfers the detected frequency signal to the physical layer controller 2.

Then, the physical layer controller 2 selects an appropriate transmission mode in a current environment from the physical layer 3, based on information on the peripheral communication environment received from the scanner 1.

Subsequently, the physical layer 3 outputs a millimeter wave through the antenna 4 in the appropriate transmission mode, based on a control signal received from the physical layer controller 2. Here, the physical layer 3 outputs the millimeter wave in the appropriate transmission mode obtained by combining a transmission frequency, a modulation method and a code rate, based on the information on the peripheral communication environment received from the physical layer controller 2.

As described above, according to the present invention, in a case where there exist different millimeter wave signals through scanning of a peripheral communication environment when transmitting a millimeter wave, the millimeter wave is transmitted by selecting an appropriate transmission mode in the scanned environment, so that it is possible to minimize signal interference and crosstalk of signals between transmission sources that exist in the same space.

Accordingly, it is possible to safely transmit a signal with the least influence from the peripheral environment.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. An apparatus for transmitting a multi millimeter wave, comprising:
a scanner configured to search for a peripheral communication environment;
a physical layer controller configured to select a transmission mode from a physical layer based on the peripheral communication environment searched by the scanner; and
the physical layer configured to have a plurality of transmission modes and to output a millimeter wave to outside through an antenna in the transmission mode selected by the physical layer controller.

2. The apparatus of claim 1, wherein the physical layer converts a transmission frequency, a modulation method and a code rate based on the selected transmission mode under the control of the physical layer controller.

3. The apparatus of claim 1, wherein the peripheral communication environment comprises information on a transmission frequency, a modulation method and a code rate, which are currently used in another transmission source.

4. A method for transmitting a multi millimeter wave, comprising:
searching for a peripheral communication environment through a scanner;
selecting another transmission mode based on the peripheral communication environment when another transmission source exists as the searched result; and
outputting a millimeter wave to outside in the selected transmission mode.

5. The method of claim 4, further comprising maintaining an existing transmission mode when another transmission source does not exist as the searched result.
